(19) United States
(12) Patent Application Publication
(10) Pub. No.: US 2019/0229533 A1
(43) Pub. Date: Jul. 25, 2019

(54) System for Energy-Usage Optimization

(71) Applicants: Mark Squire, San Diego, CA (US); Blue Sky Scientific, LLC, San Diego, CA (US)

(72) Inventors: Johann Ammerlahn, San Diego, CA (US); Mark Squire, San Diego, CA (US); Paul Loftsgard, San Diego, CA (US); Oren Hinkis, San Diego, CA (US); Andrey Dolgov, San Diego, CA (US); Petras Avizonis, San Diego, CA (US)

(21) Appl. No.: 16/255,771

(22) Filed: Jan. 23, 2019

Related U.S. Application Data
(60) Provisional application No. 62/620,764, filed on Jan. 23, 2018.

(51) Int. Cl. H02J 3/32; H02J 13/00; G05B 19/042

(52) U.S. Cl. CPC H02J 3/32; G05B 2219/2639; G05B 19/042; H02J 13/0017

(57) ABSTRACT

A system for energy-usage optimization is a system that monitors the power delivered to at least one power distribution system. Each power distribution system includes at least one power storage unit and a multiway additive switch. The multiway additive switch enables the power distribution system to selectively provide power from an sub-circuit, from the at least one power storage unit, and a combination of both the sub-circuit and the at least one power storage unit. The system may serve as a stand-alone apparatus that is connected in between the sub-circuit, through an outlet, and an electrical load. The system increases power delivery, reducing the wait-time of an electrical load to reach maximum performance. Electrical loads, preferably appliances, are no longer limited by instantaneous power availability of the sub-circuit.

The current application claims priority to U.S. provisional application Ser. No. 62/620,764 filed on Jan. 23, 2018.

### FIELD OF THE INVENTION

The present invention relates generally to systems for storing and delivering electrical energy. More specifically, the present invention relates to a system for using an energy storage device to increase the power available to a load in order to increase the peak performance of an electrical load.

### BACKGROUND OF THE INVENTION

In most countries, a wide variety of household and commercial devices, hereafter known as appliances, draw power from the commonly available electrical grid. The maximum power which these appliances can utilize at any point in time is primarily limited by the capacity of the electrical circuit to which the appliances are connected. In addition, appliances' maximum power may be further limited by the aggregate capacity of connection to the electrical grid. Compared to the power characteristics of the electrical grid, typical sub-circuits used in many appliances provide a reduced voltage and/or current. If an appliance requires more power than is available on the existing sub-circuit, a new sub-circuit may be installed, but the process may require a considerable investment of time and other resources. For example, an electric kettle comprises limitations on the amount of power that the kettle can draw from a shared sub-circuit, which in turn results in delays between the time at which the kettle is activated and the time at which the contained water is hot enough for use. For many consumers, it would be beneficial to increase the power which the electric kettle is able to apply to the contained water, thereby decreasing wait time. Depending on the capacity of the power storage mechanism and the efficiency of the actuation mechanism, the delay may be dramatically reduced.

An objective of the present invention is to provide a system and method of utilizing an energy storage mechanism to increase the power available to a load to increase the load's maximum performance. Another objective of the present invention is to provide a system and method which is preferably utilized with household appliances but can also be utilized with different applications. Another objective of the present invention is to provide a system and method which can be integrated within an electrical device or may be retrofitted to an existing electrical device. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a schematic view of the electrical and data connections of the present invention, wherein the solid lines represent the electrical connections and the dashed lines represent the data connections.

FIG. 2 is a schematic view of the electrical and data connections of the present invention, wherein a multiway switch is connected in between at least one power distribution system (PDS) inlet and a power storage unit.

FIG. 3 is a schematic view of the electrical and data connections of the present invention, wherein a multiway additive switch is connected in between the power storage unit and at least one power distribution system (PDS) outlet.

FIG. 4 is a schematic view of the electrical and data connections of the present invention, wherein a controller device is electronically coupled with a PDS.

FIG. 5 is a schematic view of the electrical and data connections of the present invention, wherein the PDS inlet and the PDS outlet are integrated onto a PDS housing.

FIG. 6 is a schematic view of the electrical and data connections of the present invention, wherein a power management system is mounted within an interior compartment of the PDS housing.

FIG. 7 is a schematic view of the electrical and data connections of the present invention, wherein an appliance is the electrical load and the appliance is electrically coupled to the PDS.

FIG. 8 is a schematic view of the electrical and data connections of the present invention, wherein the PDS is mounted within an interior compartment of an appliance housing.

FIG. 9 is a schematic view of the electrical and data connections of the present invention, wherein a remote server is communicatively coupled to the PDS and the power management system.

### DETAILED DESCRIPTION OF THE INVENTION

All illustrations of the drawings are for the purpose of describing selected versions of the present invention and are not intended to limit the scope of the present invention.

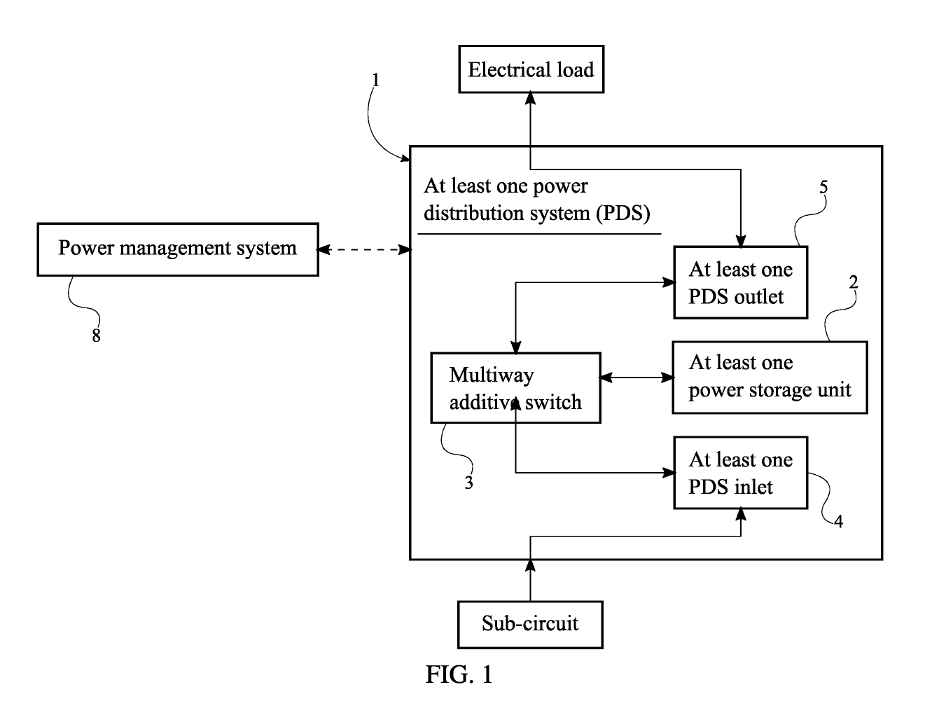

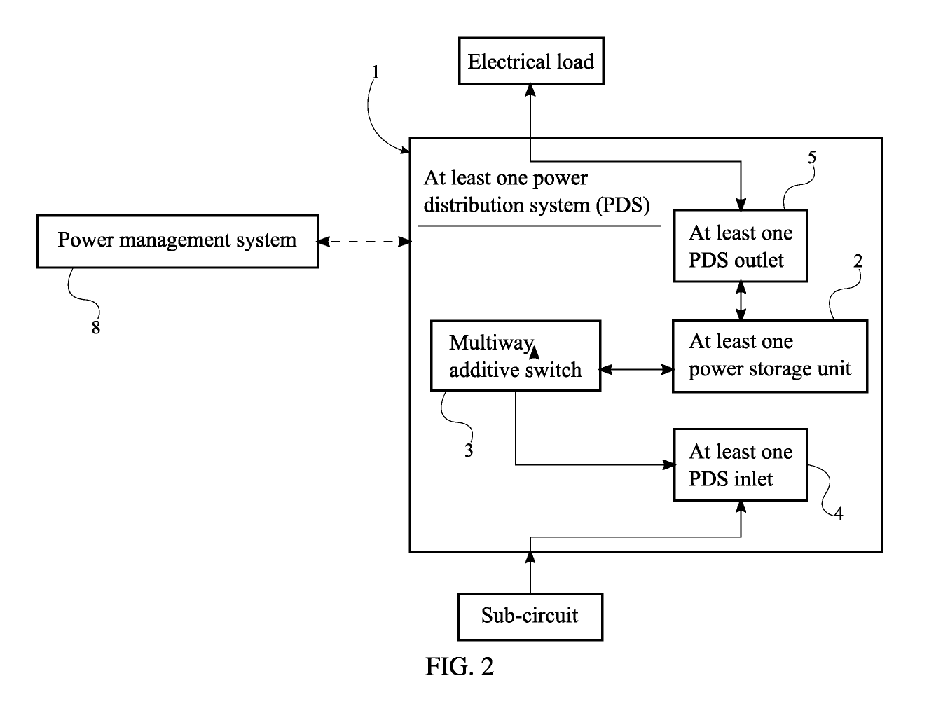

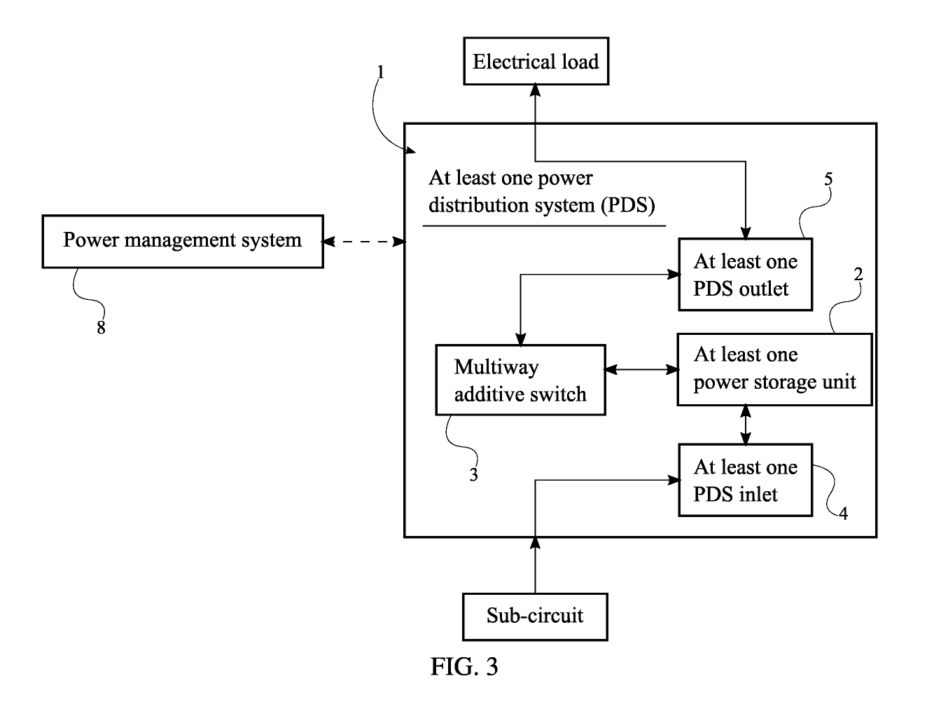

The present invention is a system that applies increased power to a variety of electrical loads. The present invention harnesses power from both a sub-circuit, also referred to as mains electricity, and stored power. The sub-circuit may include, but is not limited to, a home, a townhome, or a variety of other building structures that receives power from an electrical grid that dispenses power to a plurality of sub-circuits. Stored power is preferably accumulated while the electric grid has more generation capacity than desired, helping to stabilize the grid. Furthermore, the present invention allows an electrical load to achieve higher performance. In order for the present invention to optimize energy usage, the present invention comprises at least one power distribution system (PDS) 1, and a power management system 8, seen in FIG. 1, FIG. 2, and FIG. 3. The at least one PDS 1 stores energy from a sub-circuit which powers an electrical load. The PDS 1 comprises at least one power storage unit 2, a multiway additive switch 3, at least one PDS inlet 4, and at least one PDS outlet 5. The at least one power storage unit 2 stores power harnessed from the sub-circuit. The at least one power storage unit 2 is preferably a battery. The multiway additive switch 3 allows the user to control the distribution of power. More specifically, the multiway additive switch 3 is able to combine multiple power source while preserving the integrity of the electrical load. The at least one PDS inlet 4 and the at least one PDS outlet 5 are electrical interfaces that enable the PDS 1 to be electrically coupled to the load. Moreover, the at least one PDS inlet 4 allows the at least one power storage unit 2 and the electrical load to receive power from the sub-circuit. The at least one PDS outlet 5 allows the electrical load to harness power from the at least one power storage unit 2 and the sub-circuit. The power management system 8 acts as a central processing unit for the present invention. More specifically, the power management system 8 regulates and monitors the power stored and released by the at least one PDS 1, as well as dictates the source of power for optimized performance by the electrical load.

The overall arrangement of the aforementioned components allows an electrical load to harness power from a sub-circuit and the power distribution system. As shown in FIG. 1, the multiway additive switch 3 is operatively coupled to the at least one power storage unit 2, the PDS inlet 4, and the PDS outlet 5, wherein the multiway additive switch 3 selectively modifies the path and the quantity of energy between the PDS inlet 4, the at least power storage unit 2, and the PDS outlet 5, such that the path of electricity is either directly from the sub-circuit to the load, from the at least one power storage unit 2 to the load, or from both the sub-circuit and the at least one power storage unit 2 to the load. A user may therefore manipulate the source of power with the multiway additive switch 3. In the preferred embodiment of the present invention, the desired path of electricity is dependent on peak demand of the sub-circuit while preserving optimal performance of the electrical load. More specifically, the present invention supplies additional power that is readily available which would otherwise be limited by a sub-circuit. The power management system 8 dynamically manages power delivery to the load. The power management system 8 is communicatively coupled to the PDS 1 in order for the present invention to determine whether the power should be stored with the at least one power storage unit 2, the rate at which the power is stored, the duration and time the power is stored, and so on. In order for the power management system 8 to account for the electrical power that is supplied to and delivery by the at least one PDS 1, a plurality of sensors, more specifically a plurality of voltage sensors is integrated into the PDS inlet 4 and the PDS outlet 5.

The present invention determines when the power should be stored and when the power should be released. The preferred embodiment of the present invention increases the electrical power that is readily available to the appliance 10 when the sub-circuit is experiencing peak load. In order for the electrical load to harness energy from both the sub-circuit and the at least one power storage unit 2, the multiway additive switch 3 is connected in between the PDS inlet 4 and the at least one power storage unit 2, seen in FIG. 2. In order for the electrical load to harness energy from solely the sub-circuit, the multiway additive switch 3 is connected in between the at least one power storage unit 2 and the PDS outlet 5, seen in FIG. 3. While the sub-circuit, and consequently the electrical grid, is experiencing peak loads and the price of energy consumption is high as well, the power management system 8 modifies the path such that the electrical load harnesses energy solely from the sub-circuit. The present invention therefore reduces the energy consumption cost of a user. Moreover, the power management system 8 therefore dynamically manages power as the electrical load may draw power from both the at least one power storage unit 2 and the sub-circuit and applies power from both simultaneously. For example, if the performance of the electrical load is limited by power harnessed solely from the sub-circuit, the present invention dramatically increases the performance of the electrical load by applying energy stored by the at least one power storage unit 2 of the PDS 1 and managed by power management system 8. The preferred embodiment of the present invention further comprises a power conditioning unit which modulates the electrical power that passes through the multiway additive switch 3. The power conditioning unit protects the at least one power storage unit 2 from surges and similar electrical hazards while harnessing power from the at least one power storage unit 2. The power conditioning unit is electrically connected in between the at least one power storage unit 2 and the PDS inlet 4, thereby protecting the at least one power storage unit 2. The power conditioning unit may also be electrically connected in between the at least one power storage unit 2 and the PDS outlet 5 in order to protect the at least one power storage unit 2 while harnessing power from sub-circuit.

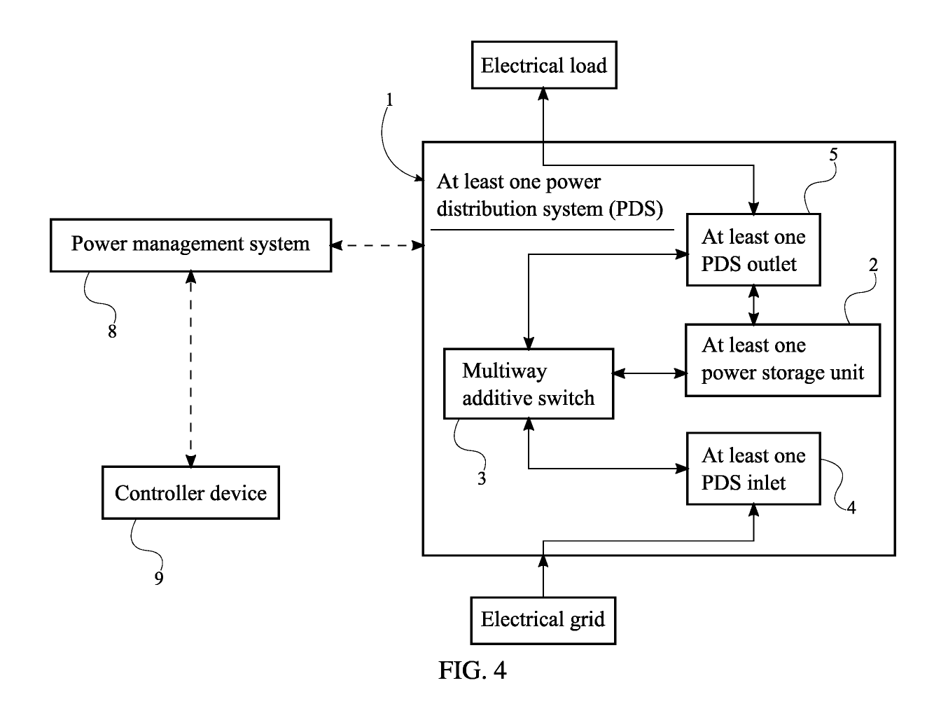

The preferred embodiment of the present invention further comprises a controller device 9, seen in FIG. 4. The controller device 9 allows a user to operate the power management system 8. The controller device 9 is an electronic system that relays information between a user and the present invention. The controller device 9 may be, but is not limited to, smartphones, tablets, and a variety of compatible controllers. The controller device 9 is electronically coupled with the power management system 8 in order for the power management system 8 to automatically operate as desired by the user. With the controller device 9, the user may transmit commands to the power management system 8 as well as receive information from the power management system 8. Consequently, the user is able to remotely control and operate the power management system 8 and the PDS 1 through the controller device 9.

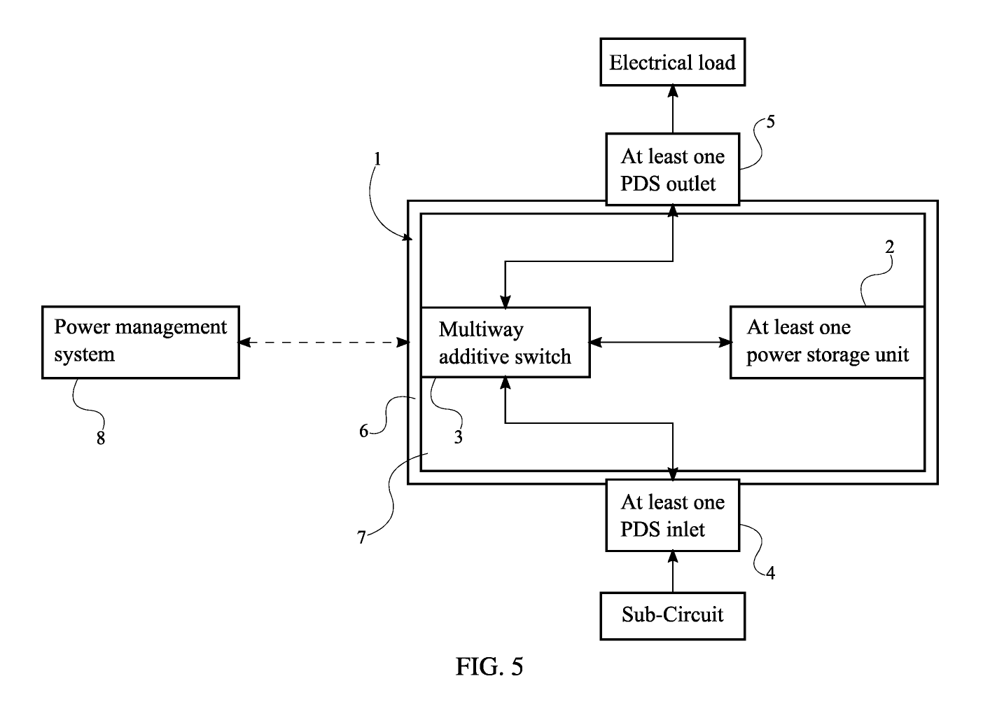

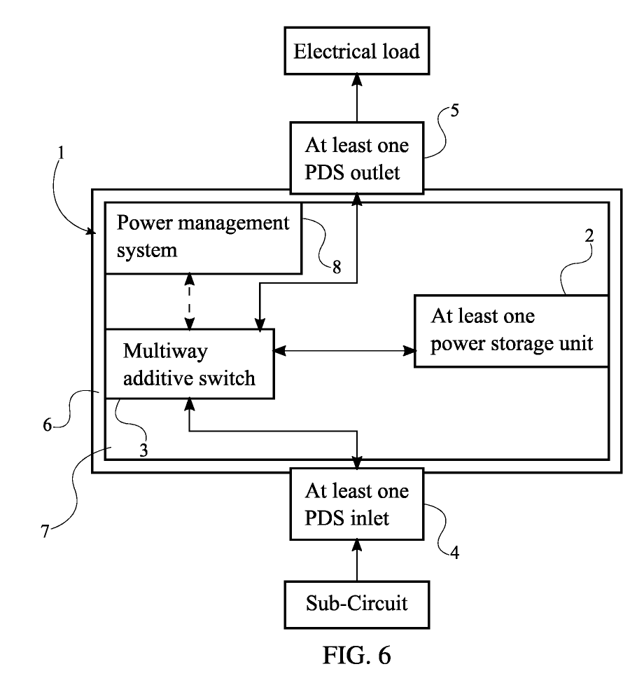

In a first embodiment of the present invention, the PDS 1 further comprises a PDS housing 6, shown in FIG. 5 and FIG. 6, in order to serve as a stand-alone device that may be connected in between the electrical load and the sub-circuit. The PDS housing 6 contains the at least one power storage unit 2 and allows the PDS 1 to be externally positioned with the electrical load. Moreover, the PDS inlet 4 is externally integrated onto the PDS housing 6. Similarly, the PDS outlet 5 is externally integrated onto the PDS housing 6. This arrangement allows the PDS 1 to harness power from the sub-circuit through a wall outlet or similar power delivery device. The electrical load may connect to the PDS outlet 5 with a power cord and the PDS 1 may directly connect with the wall outlet. More specifically, the multiway additive switch 3 and the at least one power storage unit 2 is mounted within an interior compartment 7 of the PDS housing 6, seen in FIG. 5. This arrangement allows the PDS 1 to be harness power from the sub-circuit through the PDS inlet 4. Furthermore, the power management system 8 is preferably mounted within an interior compartment 7 of the PDS housing 6, as shown in FIG. 6, so that the PDS 1 is controlled by the power management system 8 while allow the PDS 1 to serve as a stand-alone device.

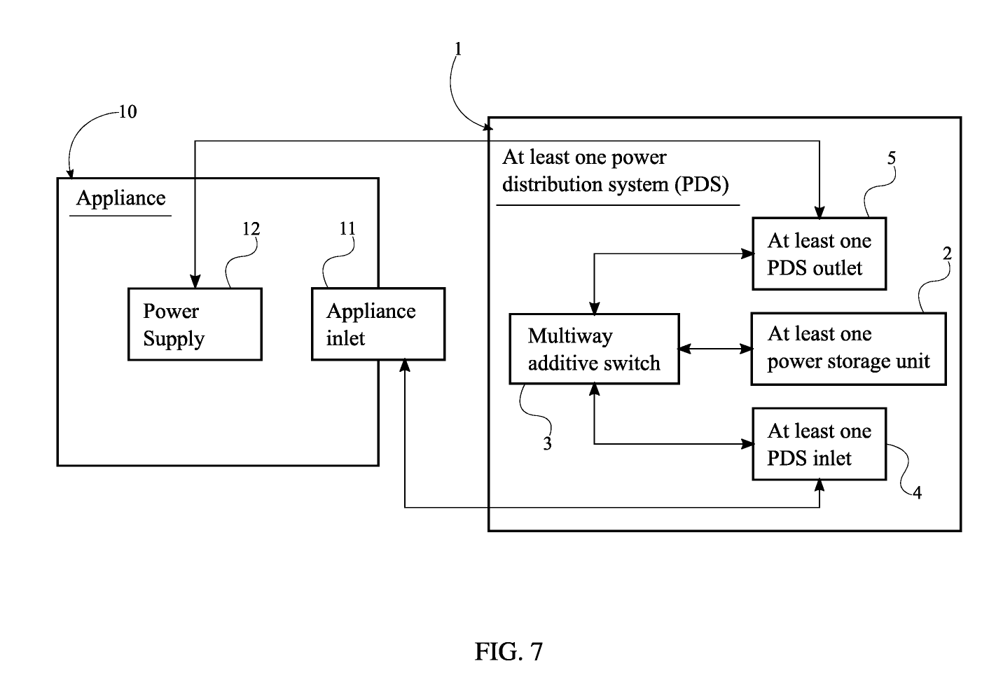

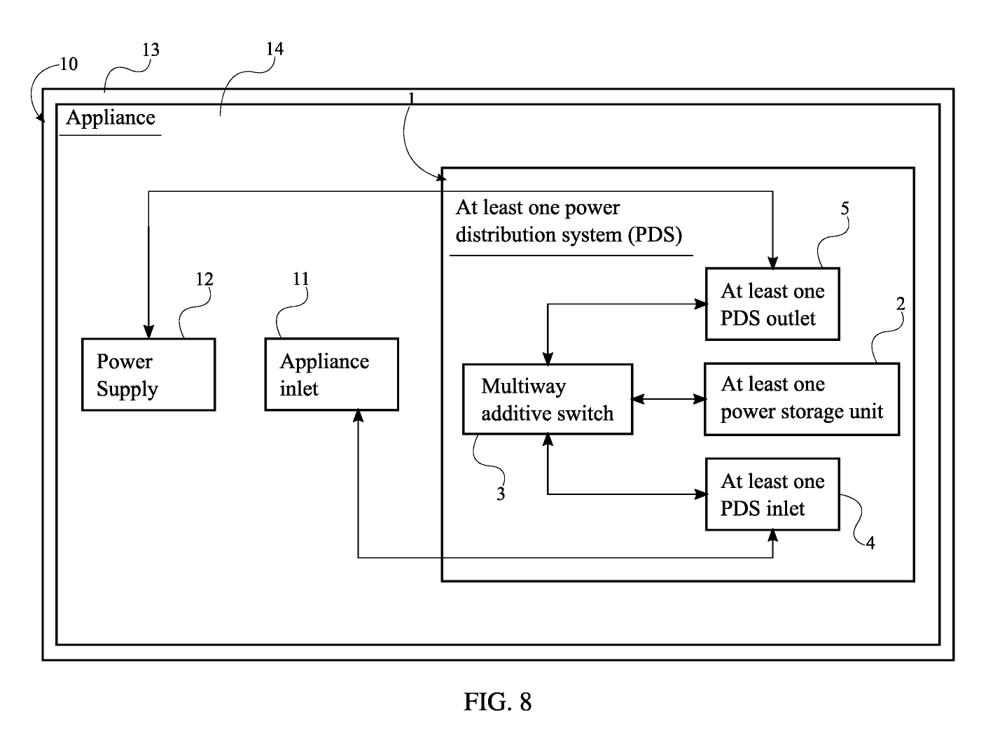

In a second embodiment, the present invention is integrated into an appliance 10. The appliance 10 may be a variety of electrical systems including, but not limited to, an electric kettle, a handheld steamer, a vacuum, an electric range, a clothes iron, and an oven. The second embodiment utilizes the PDS 1 within the appliance 10. The appliance 10 comprises an appliance inlet 11 and a power supply 12, seen in FIG. 7. The appliance inlet 11 receives power from the sub-circuit, preferably through an outlet. The appliance inlet 11 is electrically coupled to the PDS inlet 4, and the PDS outlet 5 is electrically coupled to the power supply 12. Furthermore, the appliance 10 further comprises an appliance housing 13, shown in FIG. 8. For example, the appliance 10 is an electric kettle and the heating elements, of the electric kettle within the appliance housing 13, are utilized by the power management system 8 and serve as the power supply 12 such that performance of the heating elements is directly optimized by the sub-circuit. The PDS 1 is mounted within an interior compartment 14 of the appliance housing 13. Similar to the first embodiment of the present invention, the power management system 8 in various embodiments of the present invention may be mounted within an interior compartment 14 of the appliance housing 13, allowing the appliance 10 to be a stand-alone device.

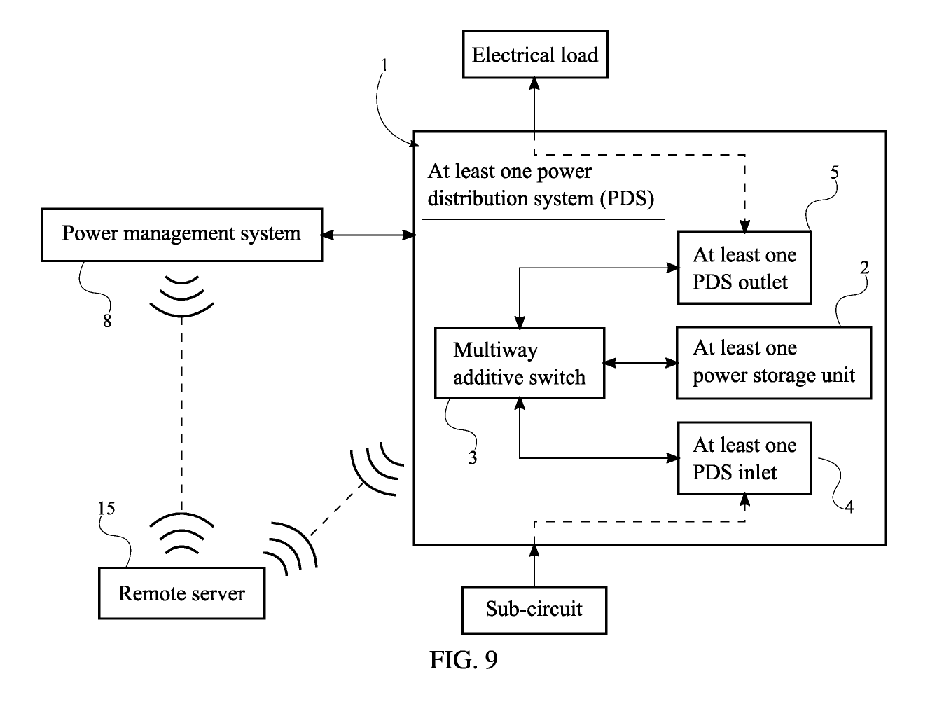

The power management system 8, and consequently the at least one PDS 1, may be controlled from a distance as alternate embodiments of the present invention may comprise at least one remote server 15, seen in FIG. 9. The at least one remote server 15 is communicatively coupled to the PDS 1 and the power management system 8 such that the source of power is remotely controlled. Moreover, multiple electrical loads and appliances may be controlled with the at least one remote server 15.

Although the invention has been explained in relation to its preferred embodiment, it is to be understood that many other possible modifications and variations can be made without departing from the spirit and scope of the invention as hereinafter claimed.

What is claimed is:

1. The system for energy-usage optimization as claimed in claim 1 comprises:
at least one power distribution system (PDS);
a power management system;
the PDS comprising at least one power storage unit, a multiway additive switch, at least one PDS inlet, and at least one PDS outlet;
the multiway additive switch being operatively coupled to the power storage unit, the PDS inlet, and the PDS outlet, wherein the multiway additive switch selectively modifies the path and the quantity of energy between the PDS inlet, the power storage unit, and the PDS outlet; and,
the power management system being communicatively coupled to the PDS.

2. The system for energy-usage optimization as claimed in claim 1, wherein the multiway additive switch is connected in between the PDS inlet and the power storage unit.

3. The system for energy-usage optimization as claimed in claim 1, wherein the multiway additive switch is connected in between the power storage unit and the PDS outlet.

4. The system for energy-usage optimization as claimed in claim 1 comprises:
a controller device; and,
the controller device being electronically coupled with the power management system.

5. The system for energy-usage optimization as claimed in claim 1 comprises:
the PDS further comprising a PDS housing;
the PDS inlet being externally integrated onto the PDS housing;
the PDS outlet being externally integrated onto the PDS housing; and,
the multiway additive switch and the power storage unit being mounted within an interior compartment of the PDS housing.

6. The system for energy-usage optimization as claimed in claim 5 comprises:
the power management system being mounted within an interior compartment of the PDS housing.

7. The system for energy-usage optimization as claimed in claim 1 comprises:
an appliance;
the appliance comprising an appliance inlet and a power supply;
the appliance inlet being electrically coupled to the PDS inlet; and,
the PDS outlet being electrically coupled to the power supply.

8. The system for energy-usage optimization as claimed in claim 7 comprises:
the appliance further comprising an appliance housing;
the PDS being mounted within an interior compartment of the appliance housing.

9. The system for energy-usage optimization as claimed in claim 1 comprises:
at least one remote server; and,
the remote server being communicatively coupled to the PDS and the power management system.

10. The system for energy-usage optimization as claimed in claim 10 comprises:
at least one power distribution system (PDS);
a power management system;
a controller device;
at least one remote server;
the PDS comprising at least one power storage unit, a multiway additive switch, at least one PDS inlet, and at least one PDS outlet;
the multiway additive switch being operatively coupled to the power storage unit, the PDS inlet, and the PDS outlet, wherein the multiway additive switch selectively modifies the path and the quantity of energy between the PDS inlet, the power storage unit, and the PDS outlet;
the power management system being communicatively coupled to the PDS;
the controller device being electronically coupled with the power management system; and,
the remote server being communicatively coupled to the PDS and the power management system.

11. The system for energy-usage optimization as claimed in claim 10, wherein the multiway additive switch is connected in between the PDS inlet and the power storage unit.

12. The system for energy-usage optimization as claimed in claim 10, wherein the multiway additive switch is connected in between the power storage unit and the PDS outlet.

13. The system for energy-usage optimization as claimed in claim 10 comprises:
the PDS further comprising a PDS housing;
the PDS inlet being externally integrated onto the PDS housing;
the PDS outlet being externally integrated onto the PDS housing; and,
the multiway additive switch and the power storage unit being mounted within an interior compartment of the PDS housing.

14. The system for energy-usage optimization as claimed in claim 13 comprises:
the power management system being mounted within an interior compartment of the PDS housing.

15. The system for energy-usage optimization as claimed in claim 10 comprises:
an appliance;
the appliance comprising an appliance inlet and a power supply;
the appliance inlet being electrically coupled to the PDS inlet; and,
the PDS outlet being electrically coupled to the power supply.

16. The system for energy-usage optimization as claimed in claim 15 comprises:
the appliance further comprising an appliance housing;
the PDS being mounted within an interior compartment of the appliance housing.
